(19) United States
(12) Patent Application Publication
(10) Pub. No.: US 2007/0131562 A1
(43) Pub. Date: Jun. 14, 2007

(54) Method and apparatus for planarizing a substrate with low fluid consumption

(75) Inventors: Zhihong Wang, Santa Clara, CA (US); Ming-Kuei Tseng, San Jose, CA (US); Yuan A. Tian, San Jose, CA (US); Yongqi Hu, San Jose, CA (US); Stan D. Tsai, Fremont, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/298,643

(22) Filed: Dec. 8, 2005

(51) Int. Cl. B23H 3/00

(52) U.S. Cl. 205/670

(57) ABSTRACT

The embodiments of the invention generally relate to a method and apparatus for processing a substrate with reduced fluid consumption. Embodiments of the invention may be beneficially utilized in chemical mechanical and electrochemical mechanical polishing processes, among other processes where conservation of a processing fluid disposed on a rotating pad is desirable. In one embodiment, a processing fluid delivery arm assembly is provided that includes a nozzle assembly supported at a distal end of an arm. The nozzle assembly includes a nozzle that is adjustable to control the delivery of fluid exiting therefrom in two planes relative to the arm. In another embodiment, processing fluid in the form of electrolyte fills holes formed at least partially through the pad as they enter the wet zone, and a current is driven through the electrolyte, filling the holes between a substrate and an electrode disposed below the surface of the pad.

### BACKGROUND OF THE INVENTION

1. Field of the Invention

The present invention generally relates to a method and apparatus for processing a substrate, and more specifically, to a method and apparatus for planarizing a substrate with reduced processing fluid consumption.

2. Description of the Related Art

FIG. 1 is a plan view of a conventional chemical mechanical polishing station 100. The polishing station 100 generally includes a rotating platen 102 having a polishing pad 104 disposed thereon. A carrier head 106 generally retains a substrate 108 (shown in phantom), such as a semiconductor workpiece, against the polishing pad 104 during processing. Typically, both the platen 102 and the carrier head 106 are rotated to provide relative motion between the polishing pad 104 and substrate 108. During processing, a processing fluid, such as an electrolyte or slurry, is typically dispensed from a nozzle 110 supported on a fluid delivery arm 112 to the pad 104 to assist in removing material from the substrate 108.

As the polishing pad 104 rotates during processing, the processing fluid disposed on the pad 104 is subjected to a centrifugal force which causes the processing fluid to run off the outer edges of the platen 102, as depicted by arrows 114. Thus, the pad 104 rotational speed, and consequently the polishing rate, must be maintained at a rate slow enough in order to ensure adequate supply of processing fluid between the substrate 108 and the polishing pad 104 during processing. The FAB operator is forced to balance the cost of diminished throughput resulting from low rotational platen speeds against the cost of high processing fluid consumption caused by fluid rapidly leaving the pad surface at high platen rotational rotation speeds. Moreover, processes high platen rotational rotation speeds may not be able to be performed if the pad is not maintained with an adequate fluid supply, thus preventing FAB operators from taking advantage of such processes. Thus, it would be desirable to enable processing to occur at higher rotation speeds without a corresponding increase in processing fluid usage.

Therefore, there is a need for an improved method and apparatus for processing substrates with reduced processing fluid consumption.

### SUMMARY OF THE INVENTION

The embodiments of the invention generally relate to a method and apparatus for processing a substrate with reduced fluid consumption. Embodiments of the invention may be beneficially practiced in chemical mechanical polishing and electrochemical mechanical polishing processes, among other processes where conservation of a processing fluid disposed on a rotating pad is desirable.

In one embodiment, a processing fluid delivery arm assembly is provided that includes a nozzle assembly supported at a distal end of an arm. The nozzle assembly includes a nozzle that is adjustable to control the delivery of fluid exiting therefrom in two planes relative to the arm.

In another embodiment, processing fluid in the form of electrolyte fills holes formed at least partially through the pad as they enter the wet zone, and a current is driven through the electrolyte, filling the holes between a substrate and an electrode disposed below the surface of the pad.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a plan view of a conventional chemical mechanical polishing station;

FIG. 2 is a partial sectional view of one embodiment of a processing station that includes one embodiment of a processing fluid delivery arm assembly having a nozzle assembly configured to control a flow of fluid therefrom in two planes;

FIG. 3 is a plan view of the processing station of FIG. 2;

FIG. 4 is a partial sectional view of one embodiment of the nozzle assembly of FIG. 2;

FIG. 5 is a partial sectional view of another embodiment of a processing station;

FIG. 6 is a partial sectional view of another embodiment of a processing station;

FIG. 7 is a partial sectional view of another embodiment of the nozzle assembly configured to control a flow of fluid therefrom in two planes; and

FIG. 8 is a sectional view of the nozzle assembly taking along section line 8-8 of FIG. 7.

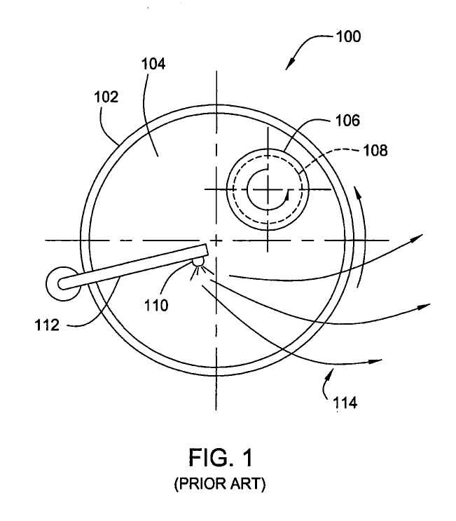

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only typical embodiments of this invention and are therefore not to be considered limiting of its scope, for the invention may admit to other equally effective embodiments.

### DETAILED DESCRIPTION

A method and apparatus for processing a substrate with reduced fluid consumption are provided. The method and apparatus may be beneficially utilized in systems where conservation of a processing fluid disposed on a rotating work surface is desirable. Although the embodiments disclosed below focus primarily on removing material from, e.g., planarizing, a substrate, it is contemplated that the teachings disclosed herein may be used to deposit materials on a substrate by reversing the polarity of an electrical bias applied between the substrate and an electrode of the system.

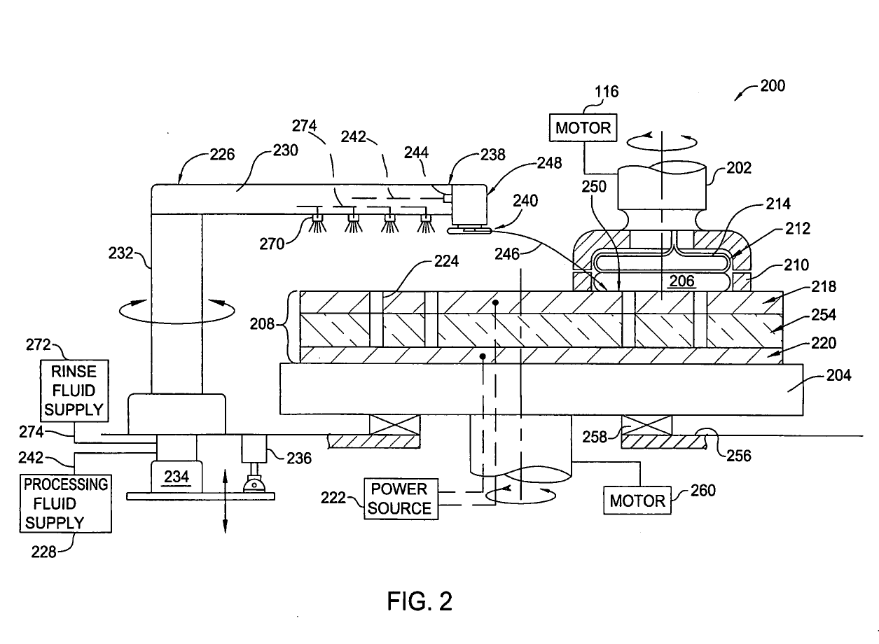

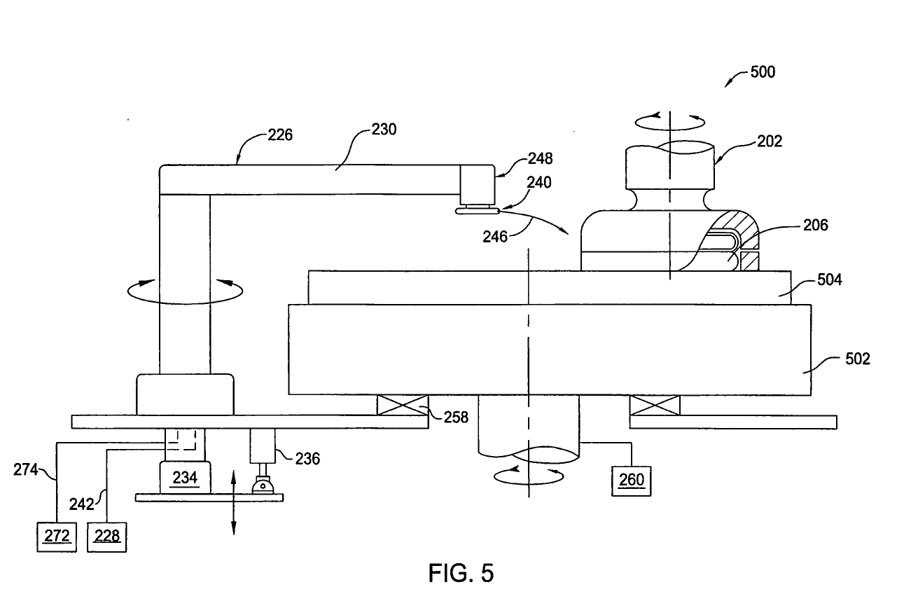

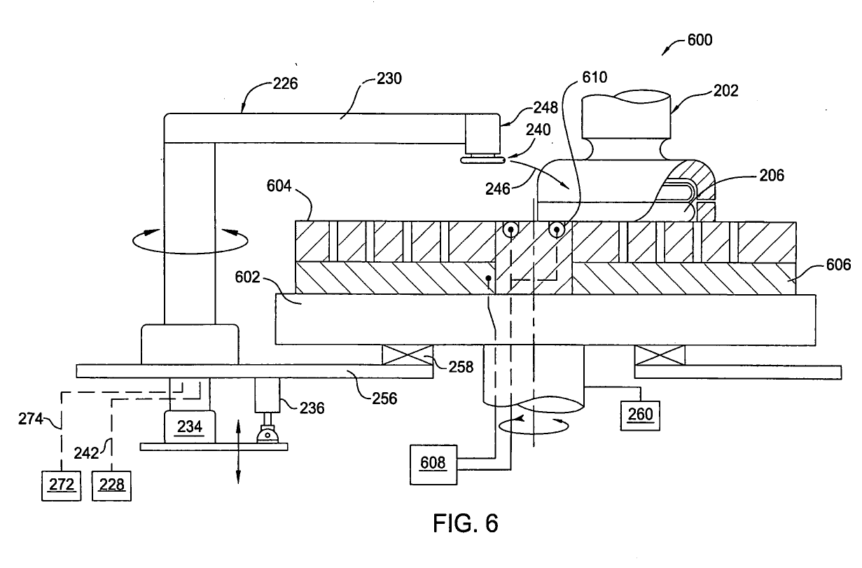

FIG. 2 depicts one embodiment of a processing station 200 having a nozzle assembly 248 configured to selectively control the orientation of a dispense of a processing fluid exiting therefrom in at least two planes. Although the processing station 200 is illustrated in FIG. 2 as an electrochemical mechanical processing station, it is contemplated that the invention may be practiced in other electroprocessing stations and conventional chemical mechanical polishing stations, such as illustrated in FIGS. 5-6, among others. Concise descriptions of the alternative exemplary processing stations of FIGS. 5-6 are detailed further below and share many of the same elements as the embodiment of FIG. 2.

Referring 210 to FIG. 2, the processing station 200 includes a carrier head 204 and a platen 202. The carrier head 204 generally retains a substrate 206 against a polishing pad 208 disposed on the platen 202. At least one of the carrier head 204 or platen 202 is rotated or otherwise moved to provide relative motion between the substrate 206 and the polishing pad 208. In the embodiment depicted in FIG. 2, the carrier head 204 is coupled to an actuator or motor 116 that provides at least rotational motion to the substrate 206. The motor 216 may also oscillate the carrier head 204, such that the substrate 206 is moved laterally back and forth across the surface of the polishing pad 208.

In one embodiment, the carrier head 204 includes a retaining ring 210 circumscribing a substrate receiving pocket 212. A bladder 214 is disposed in the substrate receiving pocket 212 and may be evacuated to chuck the wafer to the carrier head 204 and pressurized to control the downward force of the substrate 206 when pressed against the polishing pad 208. One suitable carrier head 204 is a TITAN HEAD™ carrier head available from Applied Materials, Inc., located in Santa Clara, Calif. Another example of a carrier head that may be adapted to benefit from the invention is described in U.S. Pat. No. 6,159,079, issued Dec. 12, 2001, which is hereby incorporated herein by reference in its entirety.

In the embodiment depicted in FIG. 2, the platen 202 is supported on a base 256 by bearings 258 that facilitates rotation of the platen 202. A motor 260 is coupled to the platen 202 and rotates the platen 202 such that the pad 208 is moved relative to the processing to the carrier head 204.

The polishing pad 208 is replaceably disposed on the platen 202 and provides a surface upon which the substrate 206 is processed. The polishing pad 208 may be secured to the platen 202 via adhesives, magnetic chucking, vacuum chucking or other suitable method. The polishing pad 208 may be in the form of a discrete pad or sheet, a web disposed between a take-up and supply roll, or a continuous belt.

In the embodiment depicted in FIG. 2, the polishing pad 208 includes an upper conductive layer 218 and an underlying electrode 220. Optionally, one or more intervening layers 254 may be disposed between the electrode 220 and conductive layer 218. For example, the intervening layers 254 may include at least one of a subpad, an interposed pad and a conductive carrier. In one embodiment, the subpad may be a urethane-based material, such as a foam urethane. In one embodiment, the interposed pad may be a sheet of mylar. In one embodiment, the conductive carrier may be a metallic foil. In one embodiment, the top conductive layer 218 may be comprised of one or more conductive films, such as one or more films comprised of a conductive material suspended in a polymer binder. Optionally, the films may be disposed on a conductive fabric for increased mechanical strength.

The electrode 220 is generally fabricated from a conductive material and may optionally include two or more independently biasable zones. In one embodiment, the electrode 220 is fabricated from stainless steel.

The conductive layer 218 and the electrode 220 are coupled to opposite poles of a power source 222. The power source 222 is generally configured to provide a potential difference between the conductive layer 218 and the electrode 220 of up to about 12 volts DC. The power source 222 may be configured to drive an electrochemical process utilizing constant voltage, constant current or a combination thereof. The power source 222 may also provide power pulses.

A plurality of holes 224 are formed through at least the top conductive layer 218 of the pad 208, such that a processing fluid filling the holes 224 may establish a conductive path between the electrode 220 and the substrate 206 disposed on the top conductive layer 218. The number, size, distribution, open area and pattern density of the holes 224 may be selected to obtain a desired processing result. Some examples of suitable pads which may be adapted to benefit from the invention are described in U.S. patent application Ser. No. 10/455,895 filed Jun. 6, 2003 and U.S. patent application Ser. No. 10/624,128 filed Aug. 15, 2003, which are hereby incorporated by reference in their entireties.

A processing fluid delivery arm assembly 226 is utilized to deliver a processing fluid from a processing fluid supply 228 to a top or working surface of the conductive layer 218. In the embodiment depicted in FIG. 2, the processing fluid delivery arm assembly 226 includes an arm 230 extending from a stanchion 232. A motor 234 is provided to control the rotation of the arm 230 about a center line of the stanchion 232. An adjustment mechanism 236 may be provided to control the elevation of a distal end 338 of the arm 230 relative to the working surface of the pad 208. The adjustment mechanism 236 may be an actuator coupled to at least one of the arm 230 or the stanchion 232 for controlling the elevation of the distal end 238 of the arm 230 relative to the platen 204.

The processing fluid delivery arm assembly 226 may includes a plurality of rinse outlet ports 270 arranged to deliver a spray and/or stream of rinsing fluid to the surface of the pad 208. The ports 270 are coupled by a tube 274 routed through the arm assembly 226 to a rinsing fluid supply 270. The rinsing fluid supply 270 provides a rinsing fluid, such as deionized water, to the pad 208 after the substrate 206 is removed to clean the pad 208. The pad 208 may also be cleaned using fluid from the ports 270 after conditioning the pad using a conditioning element, such as a diamond disk or brush (not shown).

The nozzle assembly 248 is disposed at the distal end of the arm 230. The nozzle assembly 248 is coupled to the fluid supply 228 by a tube 242 routed through the delivery arm assembly 226. The nozzle assembly 248 includes a nozzle 240 that may be selectively adjusted relative to the arm, such that the fluid exiting the nozzle 240 may be selectively directed to a specific area of the pad 208.

In one embodiment, the nozzle 240 is configured to generate a spray of processing fluid. In another embodiment, the nozzle 240 is adapted to provide a stream of processing fluid. In another embodiment, the nozzle 240 is configured to provide a stream and/or spray of processing fluid 246 at a rate between about 20 to about 120 cm/second to the polishing surface.

In one embodiment, the elevation of the nozzle 240 relative to the working surface of the pad 208 is between about 5 to about 30 mm, and in another embodiment is between about 5 to about 20 mm, and in a specific embodiment is about 10 mm.

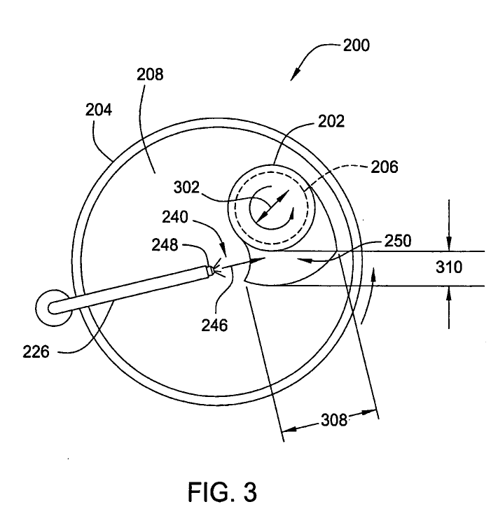

To control the consumption of processing fluid during processing, the flow rate of fluid exiting the nozzle 240 and the position of the nozzle 240 relative to the leading edge of the retaining ring 210 is selected such that fluid is delivered to the pad 208 in a wet zone 250 defined immediately upstream of the retaining ring 210. The wet zone 250 will be defined in greater detail with reference to FIG. 3 below. Thus, the holes 224 in the wet zone 250 are always filled with processing fluid from the nozzle 240, thus allowing fluid filled holes 224 to be carried under the substrate 206 without the chance of fluid being spin off the pad 208 prior to contacting (and passing under) the substrate. Thus, dispensing fluid directly to the wet zone 250 enables processing at high platen speeds without high fluid consumption, and even allows processing to occur in the presence of the fluid while other regions of the pad 208 may become substantially dry due to fluid spin-off. As the processing fluid is concentrated directly in the wet zone 250 which is immediately moving under the substrate 208 during processing, little excess processing fluid is disposed on the remaining surfaces of the pad 208 where the fluid may be spun off the pad 208 without taking part in the electrochemical process, thereby substantially reducing the consumption of processing fluid as compared to conventional processes.

FIG. 3 is a plan view of the processing station of FIG. 2 illustrating the wet zone 250 in relation to the carrier head 202/substrate 208. The wet zone 250 is defined as the area of the pad 208 surface immediately upstream of the substrate 206 as held by the carrier head 202. Upstream denotes direction from which the pad 208 is advancing under the substrate 206, as defined by the rotational direction of the platen 202. In embodiments where the carrier head 204 oscillates, as shown by arrows 302, the wet zone 250 is wider to accommodate the range of motion of the carrier head 204. Typically, a width 308 of the wet zone 250 is defined radially on the pad 208 while a depth 310 is defined in a direction normal to the pad radius. In one embodiment, the depth 310 of the wet zone 250 is bounded by the retaining ring 210 and extends upstream on the pad 208 a distance of about 30 mm. In another embodiment, the depth 310 of the wet zone 250 extends upstream on the pad 208 from the retaining ring 210 to a distance of less than about 20 mm, and in yet another embodiment, extends to a distance of less than about 10 mm. The small wet zone 250 as compared to the large pad surface typically wetted in conventional processes, allow less processing fluid to the utilized during processing, for examples, processing fluid may be delivered at a rate of less than about 400 ml/minute when planarizing 300 mm substrates.

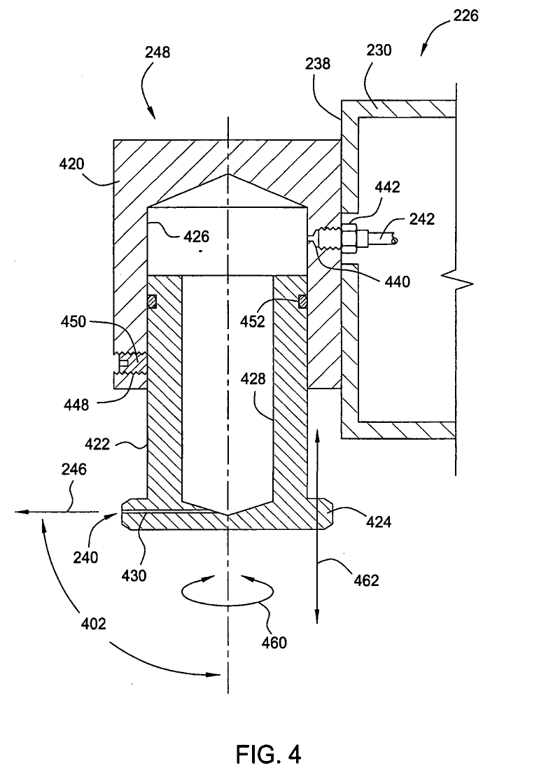

FIG. 4 is a partial sectional view of one embodiment of nozzle assembly 248 coupled to the arm 230. The nozzle assembly 248 includes a housing 420, a sleeve 422 and a head 424. The housing 420 is coupled to the distal end of the arm 230, for example, by fasteners (not shown). The housing 420 includes blind bore 426 extending into the housing 420 substantially perpendicular to the orientation of the arm 230. A port 440 is formed though the housing 420 and is configured to accept a fitting 442 to facilitate coupling the housing 420 by the tube 242 to the processing fluid supply 228 (not shown).

The head 424 is coupled to a first end of the sleeve 422. The nozzle 240 is disposed in the head 424 and is fluidly coupled to a main passage 428 formed through the sleeve 422 by a secondary passage 430. The passages 428, 430 allow the nozzle 240 to be coupled to the port 440 through the bore 426. The nozzle 240 is generally orientated to direct fluid flowing therefrom at an angle relative to the centerline of the bore 426 and sleeve 422. In one embodiment, the nozzle 240 is configured to direct the fluid at an angle 402 between about 45 to about 90 degrees relative to the centerline of the sleeve 422. In another embodiment, the nozzle 240 is configured to direct the fluid at about angle perpendicular relative to the centerline of the sleeve 422. To assist in guiding the stream or spay of fluid exiting the nozzle 240, the secondary passage 430 may have the same orientation as the fluid stream 246 exiting the nozzle 240 (i.e., the secondary passage 430 is orientated between about 45 to about 90 degrees relative to the centerline of the sleeve 422.

The sleeve 422 is at least partially disposed in the bore 426. The bore 426 and sleeve 422 are configured to allow the sleeve 422 to both rotate and slide axially within the housing 420 as shown by arrows 460, 462. A dynamic seal 452 is provided between the bore 426 and sleeve 422 to prevent fluid leakage therebetween. In one embodiment, the dynamic seal 452 is an o-ring.

A locking mechanism is utilized to set the orientation of the nozzle 240 relative to the arm 230. The locking mechanism may be a clamp, fastener, set screw, temporary adhesive, or other substance or item suitable for allowing selective repositioning of the nozzle 240 while holding the nozzle's orientation during processing. In the embodiment depicted in FIG. 4, the lock mechanism is a set screw 450.

The set screw 450 is engaged with a threaded hole 448 provided in the housing 420 to maintain a selected orientation of the sleeve 422 within the bore 426. In this manner, the orientation of the head 424 may be selected to ensure that fluid exiting the nozzle 240 is directed to the wet zone 250 of the processing pad 208. The set screw 450 may include a plastic patch on its threads to ensure the screw 450 does not inadvertently rotate. It is contemplated that the set screw 450 may be releasably secured by other methods.

FIGS. 5-6 depict alternative embodiments of a processing station configured to deliver processing fluid a wet zone. In the embodiment depicted in FIG. 5, a processing station 500 generally includes a rotating platen 502 having a polishing pad 504 disposed thereon. The polishing pad 504 is generally fabricated from a dielectric material, such as polyurethane. A carrier head 202 retains a substrate 206 against the polishing pad 504 during processing. At least one of the platen 502 or the carrier head 202 is rotated to provide relative motion between the polishing pad 504 and substrate 206 during processing.

In the embodiment depicted in FIG. 6, a processing station 600 generally includes a rotating platen 602 having a polishing pad 604 disposed thereon. The polishing pad 604 is generally fabricated from a dielectric material, such as polyurethane.

A carrier head 202 retains a substrate 206 against the polishing pad 604 during processing. At least one of the platen 602 or the carrier head 202 is rotated to provide relative motion between the polishing pad 604 and substrate 206 during processing.

An electrode 606 is disposed between the pad 604 and platen 602, and is coupled to one pole of a power source 608. The opposite pole of the power source 608 is coupled to the surface of the substrate 208 through at least one of the carrier head 202, pad 604 or platen 202. In the embodiment depicted in FIG. 6, at least one conductive element 610, for example, a plurality of balls, brushes or spring forms, is coupled to the power source 608 and disposed through the pad 604 such that the surface of the substrate 208 disposed against the pad 604 may be biased relative to the electrode 606.

In both the embodiments of FIGS. 5 and 6, a processing fluid delivery arm assembly 226 is provided to deliver processing fluid to a wet zone 302 defined on the pads 504, 604 during processing. The fluid delivery arm assembly 226 includes a nozzle assembly 248 supported by an arm 230. The nozzle assembly 248 is configured to selectively control the orientation of a dispense of a processing fluid exiting therefrom in at least two planes relative to Dispensing processing fluid to the wet zone 302 enables processing to occur with reduced fluid consumption as compared to conventional processes. Moreover, the utilization of the wet zone 302 additionally enables processing to occur at higher platen rotation speeds while maintaining a fully wetted surface under the substrate during processing.

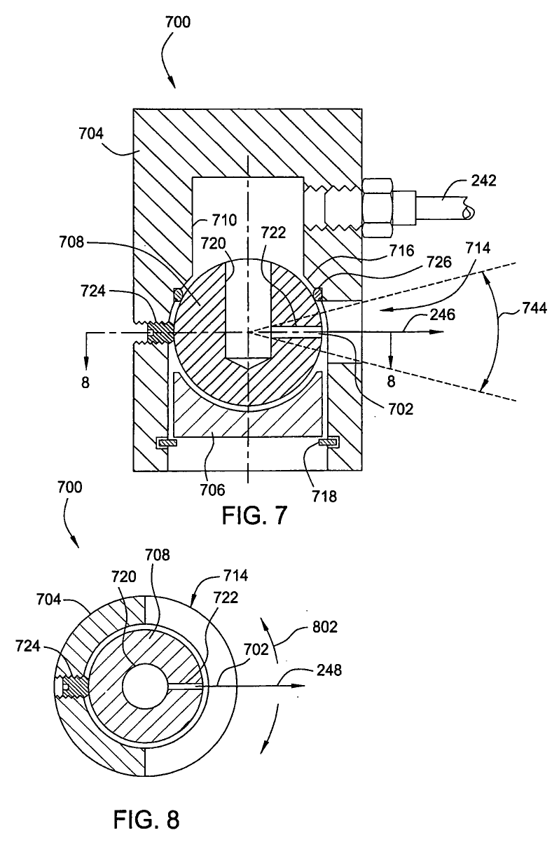

FIG. 7 is a partial sectional view of another embodiment of a nozzle assembly 700 coupled to a fluid delivery arm 750 having a nozzle 702 that is adjustable in two planes relative to the arm 750. FIG. 8 is a sectional view of the nozzle assembly 700 taken along section line 8-8 of FIG. 7. referring to both FIGS. 7-8, the nozzle assembly 700 includes a housing 704, a ball retainer 706 and a ball 708. The housing 704 includes in blind hole 710. A window 714 is formed through the housing 704 near the bottom of the hole 710.

The ball 708 is disposed in the hole 710. The hole 710 includes a curved ledge 716 that provides a bearing surface for the ball 708 and locates the ball 708 in a predefined position in the hole 710. The ball retainer 706, held by a retaining ring 718, is disposed in the hole 710 to retain the ball 708 in the hole 710 and against the ledge 716. A dynamic seal 726 is utilized to prevent leakage between the ball 708 and housing 704.

The ball 708 includes a main passage 720 coupled to the nozzle 702 by a secondary passage 722. The nozzle 702 and secondary passage 722 are generally disposed at about a right angle to the main passage 720.

The ball 708 may be selectively orientated to align the nozzle 702 with the window 714 so that fluid, entering the housing 704, may be disposed from the nozzle 702 through the window 714 to the wet zone. A locking mechanism, shown as a set screw 724, is disposed through the housing 704 to selectively set the position ball 708 such that a stream of fluid 246 flows from the nozzle 702 through the window 714 to the pad. In one embodiment, size of the window 714 is such to allow the nozzle to be rotated about 90 degrees in the horizontal plane, as shown in FIG. 8, and about 5 to about 30 degrees in the vertical plane, as shown by arrow 744 in FIG. 7. In this manner, the orientation of the dispense stream 248 exiting the nozzle 702 to the pad may be set.

Thus, a method and apparatus has been provided that enables substrate processing with reduces processing fluid consumption and/or higher rotational platen speeds as compared to conventional processes. The invention advantageously allows a greater range of rotational platen speeds, thereby increasing the process window. Moreover, as the fluid is directed to a wet zone that immediately comes in contact with the substrate, less processing fluid may be utilized for most process rotational speeds, thereby reducing the cost of consumables.

While the foregoing is directed to embodiments of the present invention, other and further embodiments of the invention may be devised without departing from the basic scope thereof, and the scope thereof is determined by the claims that follow.

What is claimed is:

1. A processing fluid delivery arm assembly, comprising:
an arm rotatable about a first end;
a nozzle assembly disposed at a second end of the arm, the nozzle assembly configured to selectively orientate a dispense a processing fluid in at least two planes relative to the arm.

2. The arm assembly of claim 1, wherein the nozzle assembly further comprises:
a housing having a port formed therein and adapted for coupling to a processing fluid source; and
a nozzle coupled to the housing and selectively orientatable in at least two planes relative to the arm.

3. The arm assembly of claim 2, wherein the nozzle assembly further comprises:
a sleeve slidably disposed in a bore of the housing having the nozzle formed in an end of the of the sleeve.

4. The arm assembly of claim 3, wherein the sleeve further comprises:
a head having a diameter greater than a diameter of the bore and the nozzle formed therein.

5. The arm assembly of claim 4, wherein the head further comprises:
a main passage formed in the head and open to the bore of the housing; and
a secondary passage formed in the head coupling the main passage to the nozzle.

6. The arm assembly of claim 5, wherein the secondary passage orientated plus or minus 30 degrees relative to horizontal.

7. The arm assembly of claim 3, wherein the housing further comprises:
a locking mechanism configured to selectively orientate the sleeve relative to the housing.

8. The arm assembly of claim 2, wherein the nozzle assembly further comprises:
a ball disposed in a bore of the housing having the nozzle formed therein.

9. The arm assembly of claim 8, wherein the housing further comprises:
a window formed therethrough and aligned with the nozzle formed in the ball.

10. The arm assembly of claim 9, wherein the ball further comprises:
a main passage formed in the ball and open to the bore of the housing; and
a secondary passage formed in the ball coupling the main passage to the nozzle.

11. The arm assembly of claim 9, wherein the housing further comprises:
a bearing surface formed in the housing and positioning the ball adjacent the window.

12. The arm assembly of claim 8, wherein the housing further comprises:
a locking mechanism configured to selectively orientate the nozzle disposed in the ball relative to the housing.

13. The arm assembly of claim 1 further comprising:
a plurality of rinse ports coupled to the arm and arranged to dispense a fluid to a surface disposed under the arm.

14. A processing system for planarizing a substrate, comprising:
a platen;
a pad disposed in the platen;
a carrier head adapted to retain the substrate against the pad during processing;
a processing fluid delivery arm having an arm supporting a nozzle, the nozzle adapted for selectively orientating a dispense a processing fluid in at least two planes relative to the arm

15. The processing system of claim 14 further comprising:
an electrode disposed between the platen and pad; and
a power source having one pole coupled to the electrode.

16. The processing system of claim 14 further comprising:
a housing having a bore formed therein;
a sleeve disposed in the bore of the housing;
a head disposed at an end of the sleeve extending from the housing and having the nozzle formed therein; and
a locking mechanism configured to selectively set a rotational orientation and an extension of the sleeve relative to the housing and the arm.

17. A method for processing a substrate comprising:
pressing a substrate against a working surface;
providing relative motion between the substrate and the working surface; and
flowing a processing fluid onto the working surface, wherein the processing fluid makes initial contact with the working surface in a wet area of the working surface defined upstream of the substrate.

18. The method of claim 17, wherein the step of flowing the processing fluid onto the working surface further comprises:
delivering the processing fluid at a rate of less than about 400 ml/minute.

19. The method of claim 17 further comprising:
rotating the working surface.

20. The method of claim 19, wherein the wet zone has a depth of less than about 30 mm.

21. The method of claim 19, wherein the wet zone has a width of about 30 mm and a depth of about 10 mm.

22. The method of claim 17, wherein the working surface further comprises:
at least one hole formed in the working surface in the wet zone and exposing a conductive layer; and
biasing the surface of the substrate relative to the conductive layer.
